(19) United States
(12) Patent Application Publication
(10) Pub. No.: US 2026/0044972 A1
(43) Pub. Date: Feb. 12, 2026

(54) METHODS AND ELECTRONIC DEVICES

(71) Applicant: Sony Semiconductor Solutions Corporation, Kanagawa (JP)

(72) Inventors: Valerio CAMBARERI, Basingstoke (GB); Adriano SIMONETTO, Basingstoke (GB); Gianluca AGRESTI, Basingstoke (GB)

(73) Assignee: Sony Semiconductor Solutions Corporation, Kanagawa (JP)

(21) Appl. No.: 19/102,858

(22) PCT Filed: Aug. 17, 2023
(86) PCT No.: PCT/EP2023/072726

§ 371 Date: Feb. 11, 2025

(30) Foreign Application Priority Data
Aug. 18, 2022 (EP) 22190927.8

(51) Int. Cl. G06T 7/521; G01S 7/4915; G01S 17/36; G01S 17/894; G06T 15/50

(52) U.S. Cl. CPC G06T 7/521; G01S 7/4915; G01S 17/36; G01S 17/894; G06T 15/506; G06T 2207/20081

(57) ABSTRACT

A method which includes applying a machine learning based model regression to a phasor image captured by an iToF sensor or phasor data obtained from the phasor image with spot illumination to obtain an estimate of the direct component of the phasor image and/or an estimate of the global component of the phasor image.

### TECHNICAL FIELD

The present disclosure generally pertains to the field of Time-of-Flight imaging, and in particular to methods and devices for Time-of-Flight image processing.

### TECHNICAL BACKGROUND

A Time-of-Flight (ToF) camera is a range imaging camera system that determines the distance of objects by measuring the time of flight of a light signal between the camera and the object for each point of the image. Generally, a Time-of-Flight camera has an illumination unit that illuminates a region of interest with modulated light, and a pixel array that collects light reflected from the same region of interest.

In indirect Time-of-Flight (iToF) cameras a scene is illuminated with infrared light produced by an active illumination device, typically using a fixed-frequency amplitude modulated continuous waveform. Three-dimensional (3D) images of the scene are captured by the iToF camera, which is also commonly referred to as “depth map”, or “depth image” wherein each pixel of the iToF image is attributed with a respective depth measurement. A depth measurement is measured by the delay of the return signal as it hits the scene and is reflected to the sensor. In iToF the delay is measured as a phase shift of correlation waveform samples computed from the return signal. The depth image can be determined directly from a phase image, which is the collection of all phase delays determined in the pixels of the iToF camera.

Although there exist techniques for determining depths images with an iToF camera, it is generally desirable to provide techniques which improve the determining of depths images with an iToF camera.

### SUMMARY

According to a first aspect, the disclosure provides a method comprising applying a machine learning model-based regression to a phasor image captured by an iToF sensor or phasor data obtained from the phasor image with spot illumination, to obtain an estimate of the direct light component of the phasor image and/or an estimate of the global light component of the phasor image.

According to a second aspect, the disclosure provides a method for training a machine learning model for direct and global light component regression, the method comprising generating training data comprising a direct ground truth phasor and/or a global ground truth phasor based on a 3D model/scene.

According to a third aspect, the disclosure provides an electronic device comprising circuitry configured to apply a machine learning model-based regression to a phasor image captured by an iToF sensor with spot illumination to obtain an estimate of the direct light component of the phasor image and/or an estimate of the global light component of the phasor image.

According to a fourth aspect, the disclosure provides an electronic device comprising circuitry configured to generate training data comprising a direct ground truth phasor and/or a global ground truth phasor based on a 3D model/scene.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the operational principle of an indirect Time-of-Flight imaging system, which can be used for depth sensing or providing a distance measurement;

FIG. 2 schematically shows a spot ToF imaging system which produces a spot pattern on a scene;

FIG. 3 schematically shows a general outline of a machine-learning (ML)-based method for the regression of direct and global phasor images;

FIG. 4a shows an exemplifying instance of the decomposition in the direct component, I_{direct}, of the ground truth phasor image (real part) as provided in a simulation of the data generation methodology;

FIG. 4b shows an exemplifying instance of the decomposition in the global component, I_{global}, of the ground truth phasor image (real part) as provided in a simulation of the data generation methodology;

FIG. 5 schematically shows an embodiment of a process performed by an ML-based model regression, wherein a deep neural network implementing an ML-based regression model which is based on a direct/global regression and which takes as input full-frame data of a full phasor frame;

FIG. 6 schematically shows an embodiment of a process performed by an ML-based model regression, wherein a deep neural network implementing an ML-based regression model which is based on a global regression and which takes as input a full-frame phasor image at the sensor resolution;

FIG. 7 schematically shows an embodiment of a concatenation process applied to a full-frame phasor image Z with sparse illumination to obtain concatenated phasor data Z_{Ω};

FIG. 8 schematically shows an embodiment of a process performed by an ML-based model regression, wherein concatenation is performed on the input data and a deep neural network implementing a ML-based regression model which is based on a direct/global regression and which takes as input one or more neighborhoods around a center location, i.e., a pixel illuminated by a sparse dot;

FIG. 9 schematically shows an embodiment of a process performed by an ML-based model regression, wherein concatenation is performed on the input data and a deep neural network implementing an ML-based regression model which is based on a global regression which takes as input one or more neighborhoods around a center location, i.e., a pixel illuminated by a sparse dot;

FIG. 10 shows a schematic representation of a training data generation method, wherein the method comprises determining a synthetic phasor image (iToF raw data) and corresponding direct and global components from a physically-based rendering based on an iToF sensor model and a direct/global separation;

FIG. 11 schematically describes the result of the separation as performed in direct/global separation of FIG. 10;

FIG. 12 illustrates a realistic example of a transient at a generic pixel, that corresponds to the data in FIG. 4;

FIG. 13 schematically shows an embodiment of a non-line-of-sight (NLOS) imaging representation;

FIG. 14 shows a flow diagram visualizing a method for training a neural network, such as for example a deep neural network, DNN, to separate the direct and the global components of the spot iToF image data by applying a data-driven, machine learning (ML)-based approach on a spot iToF image; and

FIG. 15 schematically describes an embodiment of an iToF device that can implement the processes for performing ML-based multipath interference estimation and correction in sparse iToF devices by separating the direct and global components of a full-frame phasor image captured by the iToF device.

### DETAILED DESCRIPTION OF EMBODIMENTS

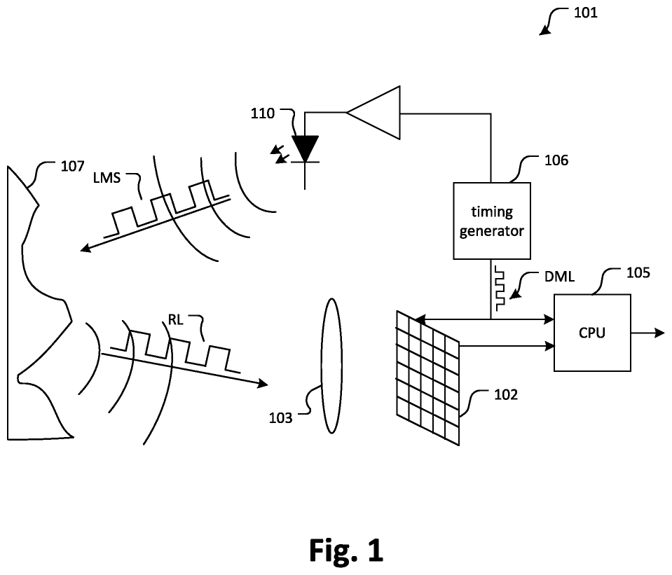

Before a detailed description of the embodiments under reference of FIG. 1 to FIG. 15, general explanations are made.

As indicated in the outset, it is generally known that the depth is measured by the delay of the return signal as it hits the scene and is reflected to the sensor. In iToF the delay is measured as a phase shift of correlation waveform samples computed from the return signal. Typically, the signal received from the iToF sensor pixels is generally comprised of a direct light component, i.e., the direct camera ray from the illuminator to the sensor as reflected by the target surface into the sensor pixel. In addition, a global light component is usually received at each sensor pixel. The global light component is a summation of multiple reflections and stray light that can be due to the sensor itself; the camera lens and optical filter stack; the scene, as caused by geometric scene features (e.g., corners, concave regions); the scene, as caused by material features (scattering, translucency).

These spurious contributions may be received by a sensor pixel and generally mix with the direct component. This may limit the accuracy of the depth measurement after processing, as the two components (direct and global) cannot be fully separated from the iToF phasors once mixed. The global light causes the Multipath Interference (MPI), as it mixes with the direct path at a certain pixel.

Among other ToF illumination patterns, spot ToF is known by which the ToF system may use an illuminator shining a sparse set of light beams, for determining a phase-shift, as well, and extracting other information on sparse scene locations captured this way.

It is known that measurement artifacts may be present, e.g., due to scattered light, MPI, or the like, which may contribute to systematic measurement error of iToF systems.

As it is generally known, direct-global separation (DGS) is already established and implemented in the software pipeline (or datapath) of Spot-iToF systems. However, DGS may have several crucial limitations such as: i) the global component may be assumed to be spatially lowpass, so that it can be estimated from the signal in the valleys without significant recovery error. This may not be the case, in particular when the object or material presents highpass spatial elements such as discontinuities and non-uniformities caused by texture or sharp scene details, ii) the global component data may not be processed beyond removal in the small local neighborhood of a spot region, while special configurations of materials and scene geometry may have much wider MPI than a single neighborhood, iii) the global component may be estimated locally for each spot region in the sensor array; however, this may limit the inference of useful information such as scene and material properties beyond the current spot, iv) there is no explicit or implicit material model being used by DGS, while a more general estimation procedure may learn DGS from such material models to extract salient properties, v) the direct component may be assumed to be a sparse sampling of an unknown dense direct component, and may have sufficiently high spatial frequency so that fine details may be captured or may be retrieved by fusion with other modalities, e.g., by interpolation with guide data, vi) the distinction between spots and valleys may be so that one does not use the full profile of the spot, as imaged on the sensor, for the estimation of the direct and global components, and vii) the subtraction of valleys may add noise to the computed phasors, thus degrading the SNR; in other words, especially for measurements with relatively low SNR on the direct component, the removal of systematic error caused by subtraction of the global component may not compensate for the additional random noise already present in ToF data, and in fact systematic error may be buried under noise.

In view of the discussion above, it has been recognized that a machine learning (ML)-based approach for separating the direct and the global components of the spot iToF data may improve the estimation of and correct the multipath interference in sparse indirect time-of-flight (spot-ToF) cameras. Such an approach may generate optically-accurate, raytraced synthetic data for providing improved ground truth direct and global components (ToF phasors) per scene under parametric or measured dot pattern illumination.

Consequently, some embodiments pertain to a method comprising applying a machine learning based model regression to a phasor image captured by an iToF sensor or phasor data obtained from the phasor image with spot illumination to obtain an estimate of the direct component of the phasor image and/or an estimate of the global component of the phasor image.

The phasor image may for example be a full-frame phasor image. The phasor image may comprise direct and global phasor data which are provided at every pixel of the iToF sensor. For example, the phasor data may be single-frequency spot-iToF data represented as phasor image Z. The phasor image may be denoted with Z and may be obtained from raw data. The iToF measurements comprise two components, namely the in-phase component (I) and the quadrature component (Q), which are respectively the real and the imaginary part of the iToF phasor.

As an indirect time-of-flight (iToF) sensor, a sparse indirect time-of-flight sensor may be used, that may be detected by infrared camera or photo-diode recordings. The ML-based model (requiring acceleration and on-device parameter storage) may be trained on a use-case specific dataset which may not generalize to different use-cases or camera modes/exposure settings. The correction of otherwise difficult to correct geometric distortions induced by MPI in depth maps and meshes may be achieved.

In some embodiments, the phasor data may be single frequency spot-iToF data. For example, the phasor data may be single-frequency spot-iToF data represented as phasor image Z.

Alternatively, the input data may be depth and amplitude images as measured by the camera, which may be computed, for example, noting that D∝<Z, A=|Z| under spot illumination.

In some embodiments, the machine learning based model regression may be applied to the phasor image to obtain an estimate of the global component of the phasor image, and wherein the method may further comprise determining an estimate of the direct component based on the estimate of the global component and based on a phasor image.

In some embodiments, the machine learning based model regression in addition to the phasor image captured by an iToF sensor or in addition to the phasor data obtained from the phasor image may take auxiliary data as further input.

The auxiliary data may be data from other modes and frequencies, a full-frame infrared or grayscale image sampled by the same sensor or phasor images at higher or lower frequencies than the reference one. Alternatively, the auxiliary data may be multi-channel image that stacks data from different channels.

In some embodiments, the machine learning-based model regression may be pretrained based on one or more ground truth images obtained based on direct/global separation of transient image of a model scene.

In some embodiments, the estimate of the direct component and the estimate of the global component may be sparse phasor images describing the direct and global components at the centers of the sparse spot illumination. For example, the phasor image, namely Z=1+iQ, may comprise direct and global phasor data (components) which are provided per spot center location, namely (I_{direct}, Q_{direct}) and (I_{global}, Q_{global}).

In some embodiments, the method may further comprises performing a concatenation (702) on one or more neighborhoods of the phasor image to obtain the phasor data.

In some embodiments, the estimate of the direct component and the estimate of the global component may be dense phasor images describing the direct and global components at the full resolution of the iToF sensor.

The embodiments also disclose a method for training a machine learning-based regression model, the method comprising generating training data comprising a direct ground truth phasor and/or a global ground truth phasor based on a 3D model/scene.

In some embodiments, the method for training a machine learning-based regression model may further comprise training the machine learning-based regression model based on the direct ground truth phasor and/or the global ground truth phasor.

In some embodiments, the method for training a machine learning-based regression model may further comprise determining a transient image from the 3D model/scene.

In some embodiments, the method for training a machine learning-based regression model may further comprise applying an iToF sensor model on the transient image.

In some embodiments, the method for training a machine learning-based regression model may further comprise applying a direct/global separation to a transient image to obtain the direct ground truth phasor and/or the global ground truth phasor.

In some embodiments, the method for training a machine learning-based regression model may further comprise illuminating the 3D model/scene by an illumination profile and rendering the 3D model/scene by a transient renderer to obtain a transient image.

The embodiments also disclose an electronic device comprising circuitry configured to apply a machine learning model-based regression to a phasor image captured by an iToF sensor with spot illumination to obtain an estimate of the direct component of the phasor image and/or an estimate of the global component of the phasor image. The electronic device may be for example an embedded device, a CPU, a GPU, or a cloud server.

Circuitry may include a processor, a memory (RAM, ROM or the like), a DNN unit, a storage, input means (mouse, keyboard, camera, etc.), output means (display (e.g. liquid crystal, (organic) light emitting diode, etc.), loudspeakers, etc., a (wireless) interface, etc., as it is generally known for electronic devices (computers, smartphones, etc.). In training phase, high amount of computational resources may be required, thus the processor may be a suitable processor. IQ data may represent raw data of an image captured by an image sensor. The image sensor may be for example an indirect time-of-flight (iToF) sensor. IQ data may include IQ values of a pixel in the pixel domain and IQ values of a spot (i.e. spot region) in the spot domain.

The embodiments also disclose an electronic device comprising circuitry configured to generate training data comprising a direct ground truth phasor and/or a global ground truth phasor based on a 3D model/scene. The electronic device may be for example a CPU device/system, a GPU device/system, or the like, without limiting the present disclosure in that regard.

Embodiments are now described by reference to the drawings.

Operational Principle of an Indirect Time-of-Flight Imaging System (iToF)

FIG. 1 schematically shows the operational principle of an indirect Time-of-Flight imaging system, which can be used for depth sensing or providing a distance measurement. The iToF imaging system 101 includes an iToF camera, for instance the imaging sensor 102 and a processor (CPU) 105. The scene 107 is actively illuminated with amplitude-modulated infrared light LMS at a predetermined wavelength using the illumination unit 110, for instance with some light pulses of at least one predetermined modulation frequency generated by a timing generator 106. The amplitude-modulated infrared light LMS is reflected from objects within the scene 107. A lens 103 collects the reflected light RL and forms an image of the objects onto an imaging sensor 102, having a matrix of pixels, of the iToF camera. In indirect Time-of-Flight (iToF) the CPU 105 correlates the reflected light RL with the demodulation signal DML which yields an in-phase component value (“I value”) for each pixel and quadrature component values (“Q-value”) for each pixel, so called I and Q values. Based on the I and Q values for each pixel a phase delay value may be calculated for each pixel which yields a phase image. Based on the phase image a depth value may be determined for each pixel which yields the depth image. Still further, based on the I and Q values an amplitude value and a confidence value may be determined for each pixel which yields the amplitude image and the confidence image.

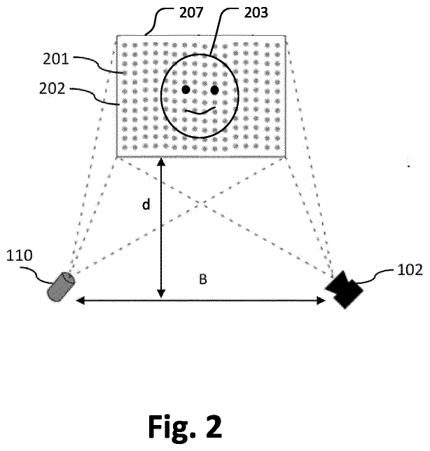

In a full field iToF system for each pixel of the image sensor 102 a phase delay value and a depth value may be determined. In a spot ToF system (see FIG. 2) a scene may be illuminated with spots by a spot illuminator and the phase a value and a depth value may only be determined for (a subset of) the pixels of the image sensor 102 which capture the reflected spots from the scene.

It should be noted that the signal received from the iToF sensor pixels is generally comprised of a direct light component, i.e., the direct camera ray from the illuminator to the sensor as reflected by the target surface into the sensor pixel. In addition, a global light component is usually received at each sensor pixel. The global light component is a summation of multiple reflections and stray light that can be due to the sensor itself, the camera lens and optical filter stack, the scene, as caused by geometric scene features (e.g., corners, concave regions), the scene, as caused by material features (scattering, translucency).

These spurious contributions may be received by a sensor pixel and generally mix with the direct component. This may limit the accuracy of the depth measurement after processing, as the two components (direct and global) cannot be fully separated from the iToF phasors once mixed. The global light causes the Multipath Interference (MPI), as it mixes with the direct path at a certain pixel.

### Spot Time-of-Flight Imaging (Spot ToF)

Spot-iToF (or Spot-ToF) cameras leverage a patterned active illuminator, so that the scene is illuminated with a few high-intensity regions following specific spatial distributions, instead of uniform illumination. This spatial diversity allows one to measure salient scene properties both on the high-intensity, actively-lit regions, whose main contribution is indeed direct light, as well as on the remaining unlit regions where any signal that may be present is due to global light (and background ambient light signal). Generally, in Spot-ToF systems the light for illuminating the scene is concentrated at the center location of light dots in a geometric, periodic pattern (e.g., a repetition of a basic triangle, square, or similar polygonal cell where the light dots are the vertices). This does not exclude the use of other patterns, such as diagonal, vertical, or horizontal line patterns (“light sheets”).

FIG. 2 schematically shows a spot ToF imaging system which produces a spot pattern on a scene.

The spot ToF imaging system comprises a spot illuminator 110, which produces a pattern 202 of spots 201 on a scene 107 comprising an object 203, here a face. An iToF camera 102 captures an image (e.g. raw image data) of the spot pattern on the scene 107. The pattern 202 of light spots 201 projected onto the scene 107 by illumination unit 110 results in a corresponding pattern of light spots in the amplitude image and depth image captured by the pixels of the image sensor (102 in FIG. 1) of iToF camera 102. The light spots will appear in the amplitude image produced by iToF camera 102 as a spatial light pattern including high-intensity areas 201 (the light spots), and low-intensity areas 202. The spot illuminator 110 and the camera 102 are a distance B apart from each other. This distance B is called baseline. The scene 107 has distance d. However, every object 203 or object point within the scene 107 may have an individual distance d from baseline B. The depth image of the scene captured by ToF camera 102 defines a depth value for each pixel of the depth image and thus provides depth information of scene 107 and object 203. Typically, the pattern of light spots projected onto the scene 107, may result in a corresponding pattern of light spots captured on the pixels of the image sensor 102. In other words, spot pixel regions may be present among the plurality of pixels (and thus in the pixel values included in the obtained image data) and valley pixel regions may be present among the plurality of pixels (and thus in the pixel values included in the obtained image data). The spot pixel regions (i.e. the pixel values of pixels included in the spot pixel regions) may include signal contributions from the light directly reflected from the scene 107 but also from other reflections (i.e. multi-path interference) and background ambient light. A spot location is a pixel region including a plurality of pixels and the center of a spot location is the center of a spot pixel region including a plurality of pixels.

Focusing on the dot pattern illumination case, part of the light on the center location is reflected by the objects in the scene. A fraction of this light is correctly captured as direct light on the sensor array at the pixel location of the corresponding camera ray. Another part diffuses off-peak and into global light component of neighboring pixels (on an extended neighborhood depending on the type of MPI) due to geometric and material properties. The sparsity of the illuminator (when compared to uniform, flat illumination) is so that one can measure such geometric and material effects from the off-peak regions. This may lead to a limited use of the sensor array into only a few spot pixel regions, while the valley pixel regions may be used to infer multipath interference.

It should be noted that in the distinction between spots and valleys one may consider that each region receives a mixture of direct light and global light: the spots receive primarily direct light, and the valleys primarily global light. Moreover, spots will receive typically higher light intensity than valley pixel regions, yielding better signal-to-noise ratio (SNR). Conversely, valleys receive typically lower light intensity and therefore lower SNR. Both regions are assumed to follow the well-known iToF noise model.

### Direct-Global Separation (DGS)

In the Direct-Global Separation (DGS) method, the direct component Z_{direct} is estimated at the spot coordinate (the center of the spot), by measuring the phasor at the center location of the spot.

The phasor Zₛₚₒₜ at the center location of the spot comprises the direct component Z_{direct}, the global component Z_{global}, and a noise component Zₙₒᵢₛₑ, spot:

$${Z}_{spot} \approx {Z}_{direct} + {Z}_{global} + {Z}_{noise , spot} .$$

The corresponding phasor Z_{valley} at the valley coordinates in a small neighborhood of the spot comprises the global component Z_{global}, and a noise component Zₙₒᵢₛₑ, valley.

$${Z}_{valley} \approx {Z}_{global} + {Z}_{noise , valley}$$

It follows that, in a single spot neighborhood (i.e., assuming the global is identical everywhere in the neighborhood), one can obtain the direct component Z_{direct} at the center location from the phasor Zₛₚₒₜ at the center location of the spot and from the phasor Z_{valley} at the valley coordinates in a small neighborhood of the spot according to:

$${Z}_{direct} \approx {Z}_{spot} - {Z}_{valley} .$$

The quality of the estimation of Z direct depends on: i) Z_{global} being a lowpass signal, so that the measurement MPI of the multi path interference at the valleys is consistent with that on the spots, ii) Zₛₚₒₜ being a sampling of the underlying scene content at sufficiently high spatial frequency, and iii) the noise contribution in the spot and valleys being removed or correctly accounted for in the estimation of Z_{direct}, for example, if the noise energy is larger than the direct signal energy one may not be able to measure the direct component via DGS, and this may result in injecting more noise in the resulting phasors.

### Machine-Learning (ML)—Based Regression Method

The embodiments described below in more detail propose machine learning (ML)-based models to estimate and correct multipath interference in sparse indirect time-of-flight (spot-ToF) cameras. The embodiments may achieve optically-accurate, raytraced synthetic data generation to provide ground truth direct and global components (ToF phasors) per scene under parametric or measured dot pattern illumination. The generated data is then used to train several flavors of a ML-based regression algorithm that reconstructs sparse or dense, direct, or global phasor images from the raw phasor input as received from the ToF sensor. The technique may find application primarily where global and direct component estimation enables multipath correction and material sensing, i.e., classification and parametric material attributes estimation.

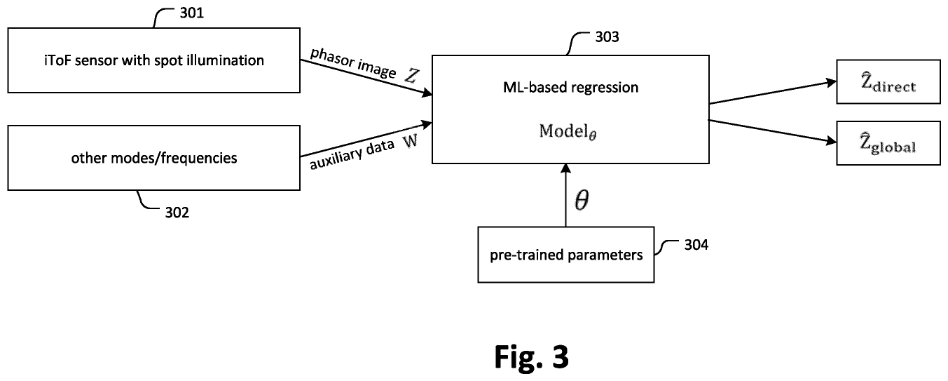

FIG. 3 schematically shows a general outline of a machine-learning (ML)-based method for the regression of direct and global phasor images. The ML-based regression model is applied at inference on the phasor image Z of an iToF sensor with spot illumination.

An iToF sensor 301 with spot illumination acquires a phasor image Z comprising phasor image data. The phasor image Z may for example be single-frequency spot-iToF data. Alternatively, the ML based regression method may be trained using depth (D∝<Z, depth is proportional to the phase ZZ of the phasor Z) and amplitude images (A=|Z|) as measured by the camera, which can be computed, for example, under spot illumination. Still alternatively, the ML based regression method can be also trained to yield the respective depth and amplitude images from the direct and global light components. This may be obtained, for example, by using the aforementioned relationships D∝<Z, A=|Z|.

Optionally, data from other modes and frequencies 302 may be used as auxiliary inputs W. Auxiliary inputs W may be a generally complex multi-channel image that stacks the auxiliary inputs. For example, other modes may be infrared under active or passive illumination.

Additionally, multi-frequency spot-iToF data, for example, dual frequency spot-iToF data, can be provided to the method in the form of additional phasor images. Additionally, guide information from another capture mode using the same sensor, such as a full-frame infrared image without active light, can be provided to the method.

The phasor image Z and, the auxiliary inputs W are transmitted as input to a deep neural network (DNN) implementing the ML-based regression model 303, e.g. Model_{θ}.

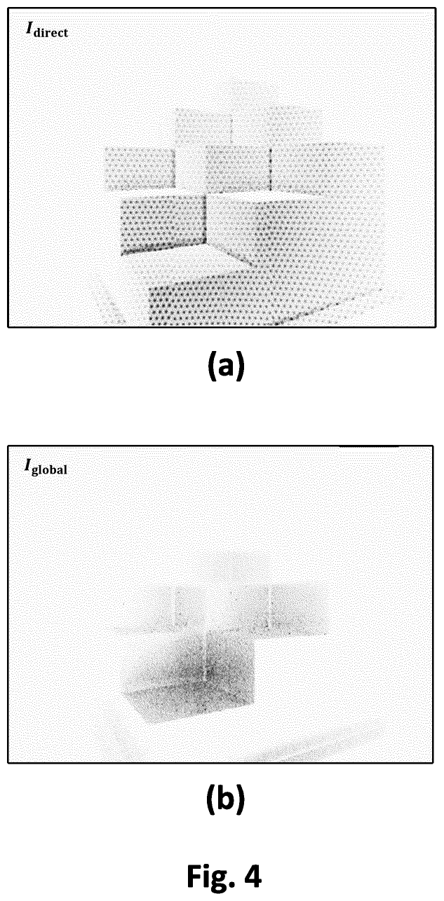

The ML-based regression model 303 operates based on a set of pre-trained parameters 304 obtained in a training phase to produce estimated phasor images Ź_{direct}, and Ź_{global} of the direct component, and, respectively, the global component at the output. The pre-trained parameters 304 may be for example the weights of a neural network. The parameters may be set by pre-training the ML-based regression model 303 with pairs of inputs and ground truth outputs (see examples of these outputs in FIGS. 4a, b). The output of the ML based regression model 303 are estimates of the full-frame phasor images of the direct and global light components, Ź_{direct}, Ź_{global}, that is the phasor image Z is decomposed in direct and global components, namely as Z≈Z_{direct}+Z_{global}, up to the presence of additive noise.

In the embodiment of FIG. 3, the ML based regression method operates on the phasor image Z or functions of the latter, such as depth and amplitude, as primary input channel. As auxiliary channels W may be (i) a full-frame infrared or grayscale image sampled by the same sensor, e.g., without active light; (ii) phasor images at higher or lower frequencies than the reference one. Still further, in the embodiment of FIG. 3, the outputs of the ML based regression method are the estimates \hat{Z}_{direct}, \hat{Z}_{global} of the full-frame phasor images of the direct and global light components. The ML based regression method separates, i.e., unmix, the input contributions related to the direct light and the global light at each pixel measured by the sensor. Alternatively, the output of the ML based regression method may be sparse, i.e., the method outputs one phasor value per center location of each spot.

It should also be noted that a full-frame phasor image Z=I+jQ is received from the iToF sensor. The phasor image may be obtained for example, after phase correction to obtain equal and linear depth-phase characteristic over the whole sensor array, i.e., Z:=γ(Z_{raw}) where γ is a generally per-pixel phase correction. This may consider iToF sensor calibration against cyclic error due to non-sinusoidal illumination and phase gradients due to lags in the propagation of the demodulation signal.

Alternatively, instead of performing phase correction, uncorrected raw data Z=Z_{raw} before phase correction may be used as input to the ML based regression model 303. Since the correction is generally a fixed phase rotation per pixel, one may defer the calibration γ to a point after direct and global estimation.

In this methodology a decomposition of the iToF in-phase component/=Re(Z) comprises I_{direct}=Re(Z_{direct}), i.e., direct light (FIG. 4(a)), and I_{global}=Re(Z_{global}), i.e., global light (FIG. 4(b)). The decomposition holds for both, full-field illumination and spot illumination. Similar holds for the quadrature component Q=Im(Z) which comprises Q_{direct}=Im(Z_{direct}), i.e., direct light, and, Q_{global}=Im(Z_{global}).

It is further noted that once the phasor image Z is provided in either of the above ways, it may or may not be processed further by denoising before providing it as input to the ML-based regression method described herein.

It is still further noted that under spot illumination, how the direct component is spatially high frequency as it is modulated by the dot pattern may observed. Conversely, the global component may be spatially low-pass because it is related to the light rays reflecting more than once in the scene, which generate this kind of effect in absence of specular reflectors, e.g., mirror-like objects.

FIGS. 4a and b show two exemplifying instances of this decomposition in direct and global components, I_{direct}, and I_{global} of the ground truth phasor image (real part) as provided in a simulation of the data generation methodology described below. The iToF phasor image is the summation of the two.

It should be noted that the iToF in-phase component/=Re(Z) which comprises the I_{direct} (FIG. 4(a)), and the global (FIG. 4(b)) is the real part of the iToF phasor. The imaginary part of the iToF phasor, namely the quadrature component Q=Im(Z), which comprises the Q_{direct}, and the Q_{global}, has similar morphology.

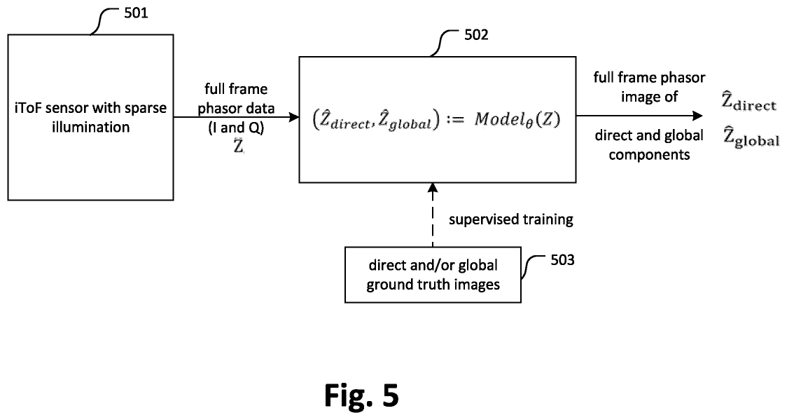

FIG. 5 schematically shows an embodiment of a process performed by an ML-based model regression, wherein a deep neural network implementing an ML-based regression model which is based on a direct/global regression and which takes as input full-frame data of a full phasor frame.

An iToF sensor 501 with sparse illumination acquires a full-frame phasor image Z, Z=1+jQ. The full-frame phasor image Z comprises IQ (In-phase and Quadrature) data. The full-frame phasor IQ data are data on the IQ domain, i.e., on the phasors as produced by the iToF sensor 501 after demodulation.

In the embodiment of FIG. 5, a full-frame phasor image Z=I+jQ is received from the iToF sensor (see FIGS. 3 and 4), since direct and global phasors (I and Q) are provided at every pixel of the sensor. A deep neural network (DNN) 502 takes as input this full-frame phasor image data

Z at the sensor resolution. The ML-based model learns to separate the direct and global components Ź_{direct}, Ź_{global} from the raw phasor image Z of an iToF sensor 301, 501 with spot illumination.

The ML-based direct/global regression model implemented by the DNN 502, using pre-trained parameters (model parameters, e.g. weights), obtains the direct and global components (\hat{Z}_{direct}, \hat{Z}_{global}):=Model_{θ}(Z). The DNN 502 outputs the estimates \hat{Z}_{direct}, \hat{Z}_{global} of the direct and global phasor image at the sensor resolution as full frame phasor images of direct and global components (i.e. regressed dense phasor data).

As indicated by the dashed arrow in FIG. 5, the pre-trained parameters are obtained in a training phase based on direct and/or global ground truth images 503. With the training of the DNN 502, a set of model parameters θ are extracted. Therefore, during the ML-based model regression, the direct light component \hat{Z}_{direct} and the global light component \hat{Z}_{global} are obtained and the result are two dense phasor images describing the direct and global components at the full resolution of the sensor (see FIGS. 4 and 305, 306 in FIG. 3). In other words, the DNN 502 performing global regression learns the joint separation and interpolation of the direct and global channels.

It should be noted that any data-driven method suitable for the solution of a regression task may be used, i.e., any method that learns model coefficients by model training with input-ground truth data pairs (Z, W)= [symbol] (Z_{direct}, Z_{global}), wherein W is (optional) auxiliary input (see 302 in FIG. 3). Such auxiliary inputs, however, are not necessarily required, i.e., it is sufficient to process (\hat{Z}_{direct}, \hat{Z}_{global}):=Model_{θ}(Z) (as shown in FIG. 3).

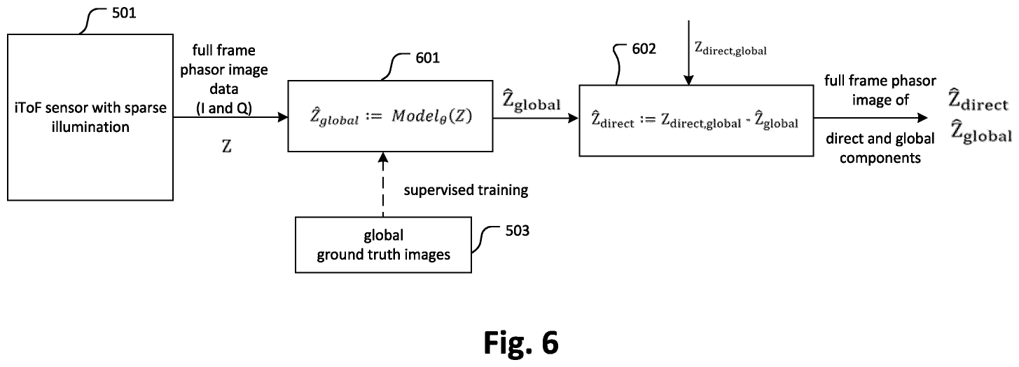

FIG. 6 schematically shows an embodiment of a process performed by an ML-based model regression, wherein a deep neural network implementing an ML-based regression model which is based on a global regression and which takes as input a full-frame phasor image at the sensor resolution.

An iToF sensor 501 with sparse illumination acquires a full-frame phasor image Z, Z=1+jQ. The full-frame phasor image Z comprises IQ (In-phase and Quadrature) data. The full-frame phasor IQ data are data on the IQ domain, i.e., on the phasors as produced by the iToF sensor after demodulation.

In the embodiment of FIG. 6, a full-frame phasor image Z=I+jQ is received from the iToF sensor (see 301 FIGS. 3 and 4), since direct and global phasors (I and Q) are provided at every pixel of the sensor. A deep neural network (DNN) 601 takes as input this full-frame phasor image data Z at the sensor resolution. The ML-based model learns to separate the direct and global components Ź_{direct}, \hat{Z}_{global} from the raw phasor image Z of an iToF sensor with spot illumination.

The ML-based global regression model Model_{θ}(Z) implemented by the DNN 601, using pre-trained parameters θ (model parameters, e.g. weights), obtains the global component Z_{global}:=Model_{θ}(Z) in an inference phase. At 602, an estimate Z_{direct} of the direct component is obtained based on the global component Z_{global} provided by DNN 601 and the full frame phasor image Z_{direct,global} according to:

$${\hat{Z}}_{direct} := {Z}_{direct , global} - {\hat{Z}}_{global} .$$

The estimates Ź_{direct}, Ź_{global} of the direct and global phasor image at the sensor resolution are then output as full frame phasor images of direct and global components (i.e. regressed dense phasor data).

As indicated by the dashed arrow in FIG. 6, the pre-trained parameters are obtained in a training phase based on direct and/or global ground truth images 503. With the training of the DNN 502, a set of model parameters θ are extracted. Therefore, during the ML-based model regression, the direct light component Ź_{direct} and the global light component Ź_{global} are obtained and the result are two dense phasor images describing the direct and global components at the full resolution of the sensor (see FIGS. 4 and 305, 306 in FIG. 3). In other words, the DNN 502 performing global regression learns the joint separation and interpolation of the direct and global channels. It should be noted that any data-driven method suitable for the solution of a regression task may be used, i.e., any method that learns model coefficients by model training with input-ground truth data pairs (Z, W) [symbol] (Z_{direct}, Z_{global}), wherein W is (optional) auxiliary input (see 302 in FIG. 3). Such auxiliary inputs, however, are not necessarily required, i.e., it is sufficient to process (Ź_{direct}, Ź_{global}):=Model_{θ}(Z) (as shown in FIG. 3).

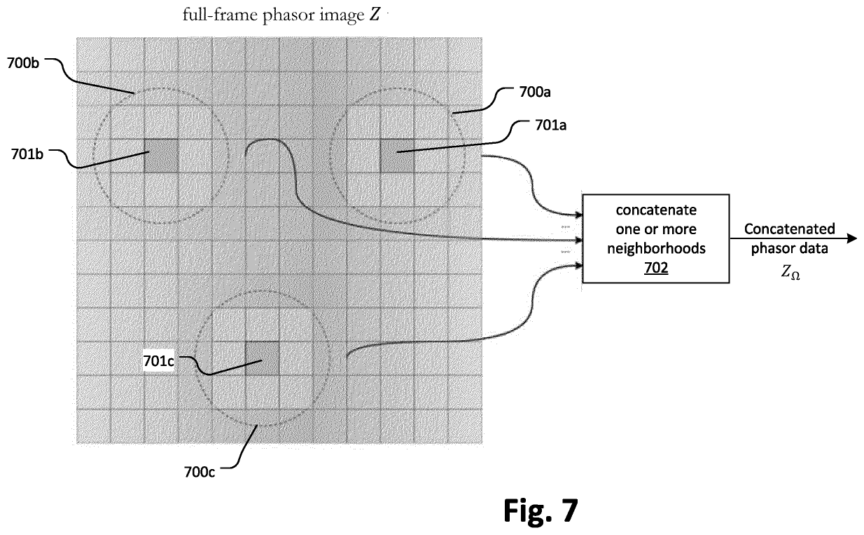

In the embodiments of FIG. 5 and FIG. 6, the full-frame phasor image Z is used as input to the regression. In alternative embodiments, some preprocessing may be applied to the full-frame phasor image Z and the regression may be based on the preprocessed data. Such preprocessing may for example comprise performing a concatenation on the input data (see FIGS. 7 to 9 below).

FIG. 7 schematically shows an embodiment of a concatenation process applied to a full-frame phasor image Z with sparse illumination to obtain concatenated phasor data Z_{Ω}. One or more neighbourhoods 700a, b, c of spot centers 701a, b, c are identified. Each neighbourhoods 700a, b, c corresponds to a spot region of the sparse illumination. The phasor information from these neighbourhoods 700a, b, c is concatenated to obtain the concatenated phasor data Z_{Ω}. For example, the different neighbors 700a, 700b and 700c can be stack in a batch (as in standard DNN) for parallel processing.

In the embodiment of FIG. 7, the receptive field of the neural network is forced to be limited to local neighborhoods as opposed to working on full-frame data (receptive field calculated depending on network topology, not forced by local neighborhood model).

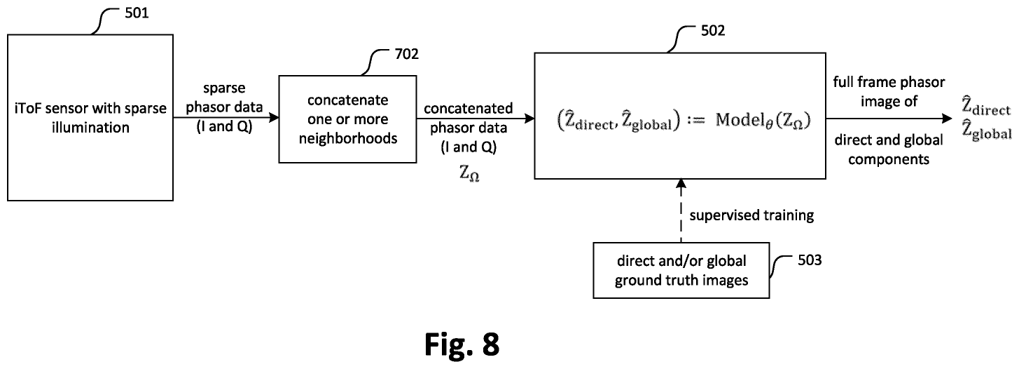

FIG. 8 schematically shows an embodiment of a process performed by an ML-based model regression, wherein concatenation is performed on the input data and a deep neural network implementing a ML-based regression model which is based on a direct/global regression and which takes as input one or more neighborhoods around a center location, i.e., a pixel illuminated by a sparse dot.

An iToF sensor 501 with sparse illumination acquires direct and global phasors (I and Q), e.g., IQ data, per spot center location. The IQ data are data on the IQ domain, i.e., on the phasors as produced by the iToF sensor after demodulation. A concatenate process 702 is performed on one or more neighborhoods to obtain concatenated phasor IQ data Z_{Ω}, as described in FIG. 7 above.

A deep neural network (DNN) 502 takes as input the concatenated phasor IQ data Z_{Ω}. The ML-based global regression model learns to separate the concatenated phasor IQ data Z_{Ω} at the center location based on local or neighborhood pixels from the raw phasor image Z of an iToF sensor with spot illumination.

The ML-based direct/global regression model implemented by the DNN 502, using pre-trained parameters (model parameters, e.g. weights), obtains the direct and global components (\hat{Z}_{direct}, Ź_{global}):=Model_{θ}(Z_{Ω}), which are two sparse phasor images describing the direct and global components only at the centers of the sparse dot illumination as full frame phasor image of direct and global components (i.e. regressed sparse phasor data).

As indicated by the dashed arrow in FIG. 8, the pre-trained parameters are obtained in a training phase based on direct and/or global ground truth images 503. With the training of the DNN 502, a set of model parameters θ are extracted. Therefore, during the ML-based model regression, the direct light component \hat{Z}_{direct} and the global light component \hat{Z}_{global} are obtained and the result are two dense phasor images describing the direct and global components at the full resolution of the sensor (see FIGS. 4 and 305, 306 in FIG. 3). In other words, the DNN 502 performing global regression learns the joint separation and interpolation of the direct and global channels.

It should be noted that any data-driven method suitable for the solution of a regression task may be used, i.e., any method that learns model coefficients by model training with input-ground truth data pairs (Z, W)= [symbol] (Z_{direct}, Z_{global}), wherein W is (optional) auxiliary input (see 302 in FIG. 3). Such auxiliary inputs, however, are not necessarily required, i.e., it is sufficient to process (Ź_{direct}, Ź_{global}):=Model_{θ}(Z_{Ω}) (as shown in FIG. 3).

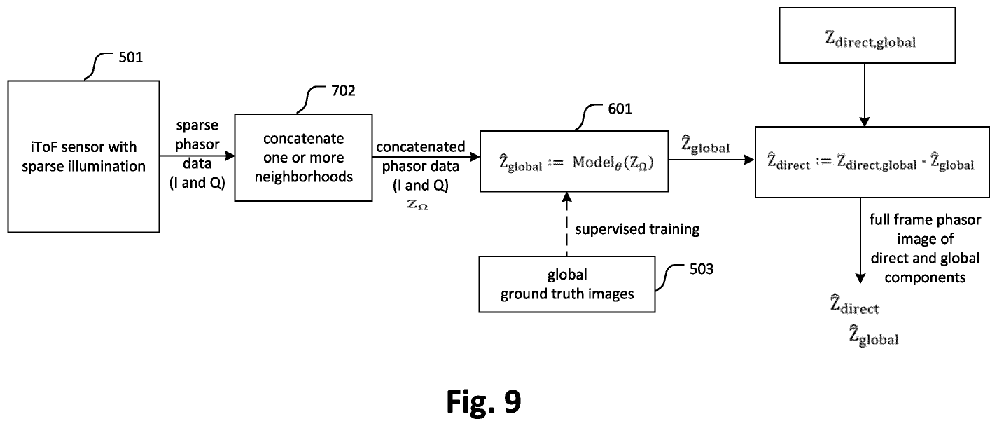

FIG. 9 schematically shows an embodiment of a process performed by an ML-based model regression, wherein concatenation is performed on the input data and a deep neural network implementing an ML-based regression model which is based on a global regression which takes as input one or more neighborhoods around a center location, i.e., a pixel illuminated by a sparse dot.

An iToF sensor 501 with sparse illumination acquires direct and global phasors (I and Q), e.g., IQ data, per spot center location. The IQ data are data on the IQ domain, i.e., on the phasors as produced by the iToF sensor after demodulation. A concatenate process 702 is performed on one or more neighborhoods to obtain concatenated phasor IQ data Z_{Ω}(see in 702 FIG. 7). The ML-based global regression model Model_{θ}(Z) implemented by the DNN 601, using pre-trained parameters θ (model parameters, e.g. weights), obtains the global component Ź_{global}:=Model_{θ}(Z) in an inference phase. At 602, an estimate Ž_{direct} of the direct component is obtained based on the global component \hat{Z}_{global} provided by DNN 601 and the full frame phasor image Z_{direct,global} according to:

$${\hat{Z}}_{direct} := {Z}_{direct , global} - {\hat{Z}}_{global} .$$

The estimates Ź_{direct}, \hat{Z}_{global} of the direct and global phasor image at the sensor resolution are then output as full frame phasor images of direct and global components (i.e. regressed dense phasor data).

The DNN 601 outputs the estimates Ź_{direct}, \hat{Z}_{global} of the direct and global phasor image only at the centers of the sparse dot illumination as full frame phasor image of direct and global components Ź_{direct}, \hat{Z}_{global}, (i.e. regressed sparse phasor data). In this manner, the DNN 601 learns to regress the concatenated phasor IQ data Z_{Ω} at the center location based on local or neighborhood pixels from the raw phasor image Z of an iToF sensor 501 with spot illumination and outputs two sparse phasor images describing the direct and global components Ź_{direct}, Ź_{global}.

In the embodiment of FIG. 9, the ML-based model learns to separate the direct and global components \hat{Z}_{direct}, \hat{Z}_{global} from the raw phasor image Z of an iToF sensor with sparse illumination. With the training of the DNN 502, a set of model parameters θ are extracted so that the global component Ź_{global}:=Model_{θ}(Z_{Ω}) is obtained at inference. The direct component is obtained using the \hat{Z}_{direct}:=\hat{Z}_{direct,global}−\hat{Z}_{global}. As indicated by the dashed arrow in FIG. 9, the pre-trained parameters are obtained in a training phase based on direct and/or global ground truth images 503.

It should be noted that any data-driven method suitable for the solution of a regression task may be used, i.e., any method that learns model coefficients by model training with input-ground truth data pairs (Z, W)= [symbol] (Z_{direct}, Z_{global}), wherein W is (optional) auxiliary input (see 302 in FIG. 3). Such auxiliary inputs, however, are not necessarily required, i.e., it is sufficient to process (\hat{Z}_{direct}, \hat{Z}_{global}):=Model_{θ}(Z_{Ω}) (as shown in FIG. 3).

It should be further noted that the embodiment of FIG. 9 is similar to that of FIG. 5 with global-only estimation and a residual model for direct-global separation.

It should also be noted that any possible combination of the inputs and outputs and the embodiments described in FIGS. 5 to 9 may be used to implement the ML-based regression method.

Among such models, the most natural is a deep neural network (DNN) architecture such as a network comprised of multilayer perceptron or fully connected layers (see FIGS. 8 and 9), or a network comprised of convolutional layers, a kernel prediction network, or a vision transformer (see FIGS. 5 and 6).

Among non-DNN models, non-linear regression with radial basis functions may be applied, or random forests for the embodiments of FIGS. 5 to 9, wherein the embodiments of FIGS. 5 to 6 may be computationally more demanding than the embodiments of FIGS. 7 to 9.

The common point of such models is that their training yields a set of parameters θ that can be used at inference to predict unknown, unobserved (Ž_{direct}, Ž_{global}).

### Training and Data Generation

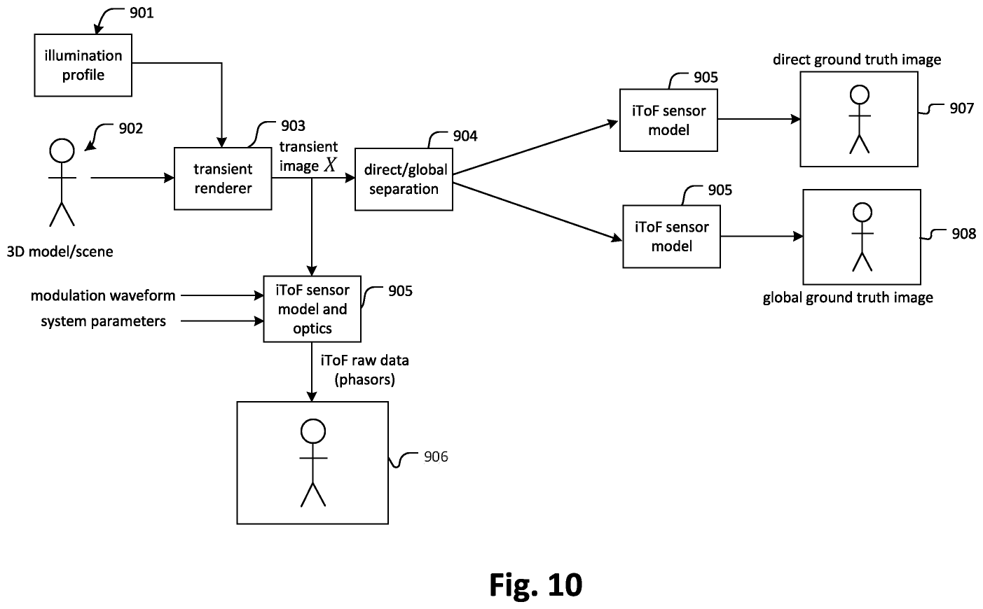

FIG. 10 schematically shows a schematic representation of a training data generation method. The method comprises determining a simulated phasor image (iToF raw data) and corresponding direct and global components from a physically-based rendering based on an iToF sensor model and a direct/global separation. The simulated phasor image is a synthetic phasor image.

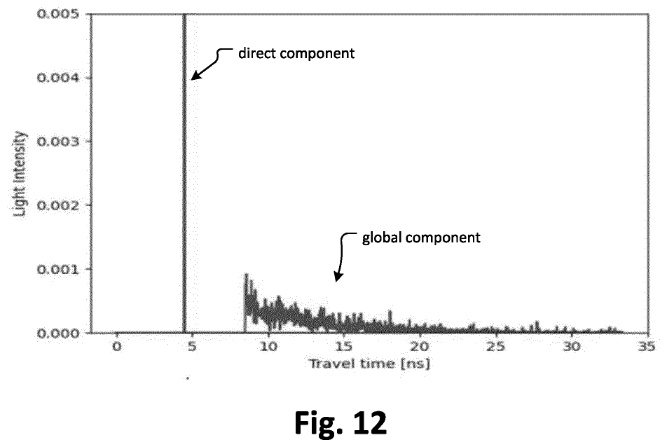

A 3D model or scene 902 illuminated by an illumination profile 901 is rendered by a transient renderer 903 to produce a transient image X, such as a histogram (see FIG. 12) that depicts the intensity over time. The transient image X is (virtually) processed by an iToF sensor model and optics 905 to generate iToF raw data 906 (a full-frame phasor image of the scene 902), e.g. synthetic dataset 1005 for training the ML-based models. The illumination profile 901 is for example described by means of parametric or non-parametric radiant source intensity profile. The iToF sensor model 905 models characteristics of an iToF sensor, e.g. the correlation of the signal produced by the incident light on a pixel with the demodulation signal (DML in FIG. 1).

The transient image X is obtained by the transient renderer 903 using a raytracing technique. This transient renderer 903 (raytracer) is the core common element of the approach described here which, given a 3D model 902 representing the geometry and the material properties of a target scene and given the illumination pattern 901 representing how the spot iToF camera is illuminating the scene in a sparse way, provides time-resolved, transient rendering describing light transport for each of the pixels. This produces a transient image X which represents the scene response to an ideal, infinitely short (in time) light pulse as observed and illuminated from the iToF camera view. The transient image describes at each pixel a histogram of times of arrival of photons (x axis) vs. photon counts (y axis). The iToF model generates the iToF response given this per-pixel histogram.

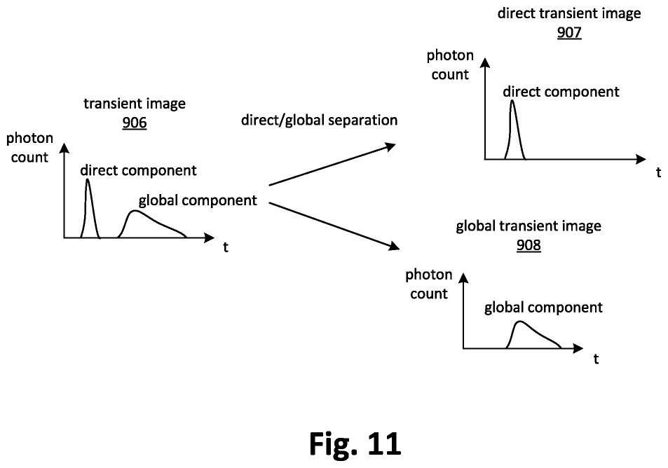

A direct/global separation 904 is performed on the transient image to separate it in direct and global transient components by bandpass filtering (see also FIG. 11) on the transient image generated by physically-based, time-resolved rendering. The direct/global separation 904 may for example obtain the direct transient component by limiting the raytracing to a maximal number of one reflection. Accordingly, the direct/global separation 904 may for example obtain the global transient component by limiting the raytracing to more than one reflection, i.e. by disregarding any (“direct”) rays that are reflected only once on the scene. The direct and global transient components are fed separately to the iToF sensor model 905 to obtain a direct ground truth phasor 907 and a global ground truth phasor 908.

It should be noted that the transient image includes light intensity information and light path length information. Using this information may be possible to recreate the transient image.

FIG. 11 schematically describes the result of the separation as performed in direct/global separation 904 of FIG. 10. In other words, FIG. 11 depicts a transient (a histogram) at one generic pixel as received on the sensor plane, before computing the iToF response. A (virtual) transient image 906 obtained by raytracing comprises a direct light component and a global light component. Each pixel of the transient image 906 is associated with a respective histogram of photon counts over time. The histogram comprises events related to the direct light component and events related to the global light component. On the transient image, H x W x B, where B is the number of histogram bins, His the height of the histogram bins and W is the width of the histogram bins. The direct/global separation separates these components into two different transient images, namely a direct transient image 907, and a global transient image 908.

The iToF raw data 906 and the ground truth phasor 907 and the global ground truth phasor 908 are used as training data in a training process to obtain the pretrained parameters of the ML-based model. In particular during training, the iToF raw data 906 (phasor image Z in FIG. 5) is fed to the ML-based model (502 in FIG. 5) as input and the ML-based model produces respective direct and global components as output. The parameters of the ML-based model are optimized until the direct and global components obtained by ML-based model are as close as possible to the ground truth phasor 907 and the global ground truth phasor 908. In the training phase this optimization is typically done with a larger set of transient images obtained from multiple scenes with different objects, object positions, camera orientations, and so forth.

In the embodiment of FIG. 10, the ML-based model may be trained in a supervised way by using a training set comprising the iToF input Z and (optionally) auxiliary inputs W, and the ground truth direct and global phasors Z_{direct}, Z_{global} at the desired location. This realizes instances of the mapping (Z, W)= [symbol] (Z_{direct}, Z_{global}) which is learnt by the ML-based regression model. The ground truth phasor 907 and/or the global ground truth phasor 908 may be used as training data in a training process to obtain the pretrained parameters of the ML-based model.

The nature of this training set is synthetic, i.e., obtained by rendering of 3D models and assets using illuminator, lens, and sensor models to describe the iToF camera system. By this rendering, the ground truth direct and global are obtained, as well as the corresponding input iToF phasor image Z and auxiliary images W.

Alternatively, the training set described in FIG. 10 above may be realized, i.e., obtained by recording data via an iToF camera system, while the ground truth data may be obtained by recording data via another device such as a structured light or LiDAR 3D scanner, and annotating the resulting mesh data with known material models. Also in this case, the schematic representation of the data generation described in FIG. 9 above may be used with inputs being 3D models and assets recorded by a ground truth device.

Still alternatively, this training set may be realized, i.e., obtained by recording data via an RGB or IR camera system, e.g., iToF signal amplitude, providing 3D reconstruction by means of dense structure-from-motion/multiview synthesis methods and annotating the resulting mesh data with known material models. For example, B. Attal et al., propose such dense structure-from-motion/multiview synthesis methods at the published paper “TöRF: Time-of-Flight Radiance Fields for Dynamic Scene View Synthesis,” Advances in Neural Information Processing Systems, vol. 34, 2021. These dense structure-from-motion/multiview synthesis methods are also known in the state of the art such as COLMAP, or KinectFusion.

Also in this case, the schematic representation of the data generation described in FIG. 10 above may be used with inputs being 3D models and assets generated by a 3D reconstruction algorithm from IR or RGB camera data. This last approach may be considered self-supervised, i.e., the algorithmic pipeline itself provides data to train the network for this regression task. It should be noted that the above-described model may be implemented for spot iToF illumination as well as for full filed iToF illumination, as long as the illumination profile and light shading (illuminator model) is provided to transient renderer.

It should further be noted that in the embodiments of FIGS. 5 to 10, direct-global separation is performed from full-frame spot-iToF phasor images by means of a ML-based method, using data generation by raytracing to obtain ground truth that enables precise training of the latter ML-based method parameters.

In the embodiment of FIG. 10 the transient image X for a single iToF camera pixel is shown in the histogram of FIG. 12 per pixel. The abscissa represents the travel time of the emitted light in ns and the ordinate represents the intensity of the emitted light. Its first component (vertical straight line) is the direct transient image component X_{direct} and it is related to the light rays bouncing only once in the scene and directly into the iToF camera. The second component is the global transient image component, and it is related to all the light rays bouncing multiple times in the scene and which is referred as X_{global}.

The transient image X generated by the transient renderer 903 is fed to the iToF sensor model Φ implemented by the iToF sensor and optics 905, which estimates the iToF output from it by emulating iToF camera modulation and demodulation signals. These are convolved with the transient image to obtain a realistic camera response given the modulation waveform. Moreover, sensor-related noise and distortion sources, for example, thermal noise, lens, and sensor scattering, tap imbalance are also part of the iToF sensor model.

As an example, the sensor model may consist of a matrix with four rows and as many columns as the time bins of the transient image X. Each row of Φ is a cosine function with a different internal phase shift φ ∈ [0 π/2, π, 3π/2]. Through the matrix multiplication m=ΦX, which holds at every pixel in the sensor array, simulate the well-known four-taps sampling of an iToF camera. Other noise sources, such as shot noise, can then be generated on m. From m we can then build the corresponding iToF phasor Z=I+jQ as well known in basic iToF principles, reading

$$I = {m}_{0} - {m}_{π} ; Q = {m}_{\frac{3 π}{2}} - {m}_{\frac{π}{2}}$$

where the subscripts denote the corresponding internal phase shift φ. The application of this model indeed yields the input iToF phasor image Z.

The same exact procedure can be applied to the direct and global phasor images. The transient image is bandpass-filtered in its direct and global transient components, and these may be fed into the sensor model Φ, yielding the ground truth phasor images Z_{direct} and Z_{global}.

It should be noted that the spot or pattern illuminator may be generally modelled by its radiant source intensity profile RSI (0, ¢) in polar coordinates (horizontal/vertical angles). This profile may be parametric, e.g., it may be explicitly generated by a grid of Gaussian pulses based on an elementary periodic cell. Alternatively, it may be non-parametric, i.e., as measured from a photo-goniometer set-up providing a discretization of the RSI (0, ¢).

FIG. 12 illustrates a realistic example of a transient at a generic pixel, that corresponds to the data in FIG. 4. The transient of FIG. 12, at a single pixel, can be separated by a band-pass histogram filter into the direct and global components that are shown, for all pixels, as I and Q components of the iToF signal corresponding to this transient.

### Applications and Use-Cases

Spot-iToF is inherently low-power and suitable for mobile device applications, for example, short range, front or rear facing. The ML-based regression method described herein may be employed for three-dimensional (3D) Reconstruction, material sensing, non-line-of-sight (NLOS) imaging, and the like.

### 3D Reconstruction

The main use case for spot-iToF which is significantly affected by multipath interference is 3D reconstruction in short-range scanning applications. Multipath is empirically more critical in short range rather than long range, where the main issue is low SNR. The direct component estimated with the proposed invention may be used to retrieve multipath-free depth maps and consequently more accurate 3D point clouds/meshes from spot-ToF data irrespectively of the material, for example, translucent, as the direct component rejects geometric distortion caused by the global component.

### Material Sensing

Salient properties of a material may be inferred from its global component of the iToF data, e.g., by extracting features from the global phasor image, the global amplitude, or the direct amplitude-global amplitude ratio or vice versa, among others. Moreover, considering correct geometry in the direct component and the spatial patterns in the global component, one may distinguish between scene multipath (see FIG. 4, where the concave corners of the object cause high global component amplitude) and sub-surface scattering (where the distortion assumes patterns that are inconsistent with simple scene geometry-induced multipath). ML-based models may therefore classify materials using hand-crafted features from global component (amplitude, geometry) or learned features in DNN-based approaches, e.g. anti-spoofing from sub-surface scattering.

### Non-Line-of-Sight (NLOS) Imaging

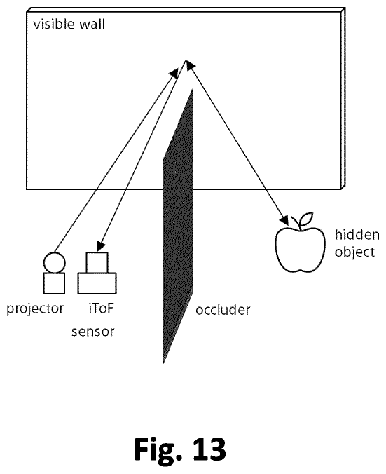

The global component Z_{global} may be generated by all the light rays which bounced more than one time inside the scene, and for this reason it encodes information about scene points which may not be directly illuminated and/or observed by the iToF camera. In the published paper “A theory of Fermat paths for non-line-of-sight shape reconstruction.”, of Xin, Shumian, et al., Proceedings of the IEEE/CVF Conference on Computer Vision and Pattern Recognition. 2019, the light source and sensor are pointing at an intermediate wall. The light bounces on the wall, hits an object hidden from sight and comes back to the sensor bouncing again on the wall. The schematic representation of this set-up is shown in FIG. 13, which is an optional scenario. In this scenario, the global component encodes information regarding the object hidden from sight, e.g., object position, shape, and material properties, and by using an ad-hoc data-driven approach, this information is retrieved. A specific synthetic dataset, based on the pipeline described in FIG. 10, may be generated to train the data-driven approach described herein.

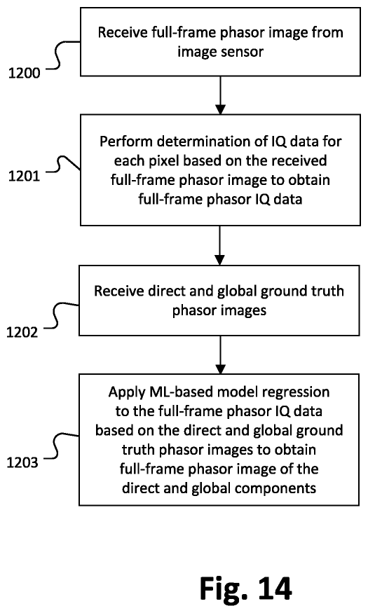

FIG. 14 shows a flow diagram visualizing a method for training a neural network, such as for example a deep neural network (DNN) to separate the direct and the global components of the spot iToF image data by applying a data-driven, machine learning (ML) based approach on a spot iToF image.

At 1200, a deep neural network (DNN) implementing a data-driven, machine learning (ML) based model receives, as input data, a full-frame phasor image from an image iToF sensor. At 1201, determination of IQ data for each pixel based on the received full-frame phasor image is performed to obtain full-frame phasor IQ data. At 1202, the DNN receives direct and global ground truth phasor images, as training data, i.e. pre-trained parameters. At 1203, the ML-based model regression is applied by the DNN to the full-frame phasor IQ data based on the direct and global ground truth phasor images to obtain full-frame phasor image of the direct and global components.

In the embodiment of FIG. 14, a method during the training phase of the DNN is described. After the raining phase, the DNN learns to output the full-frame phasor images of the direct and global components without the direct and global ground truth phasor images.

In the embodiment of FIG. 14, a DNN is used to perform the ML-based regression method, without limiting the present embodiment in that regard. The DNN is a network comprised of multilayer perceptron or fully connected layers (FIGS. 7 and 8), or a network comprised of convolutional layers, a kernel prediction network, or a vision transformer (FIGS. 5 and 6). Alternatively, a non-DNN model may be used. For example, among non-DNN models, non-linear regression with radial basis functions may be applied, or random forests for the embodiments of FIGS. 5 to 8.

It should be noted that the DNN may be trained with a mix of real and synthetic data according to other methodologies, e.g. neural network fine-tuning, domain adaptation, or the like. The algorithm is used by inference/prediction with a pre-trained model that receives as input phasor data and separates direct and global components based on its learned patterns from IQ data.

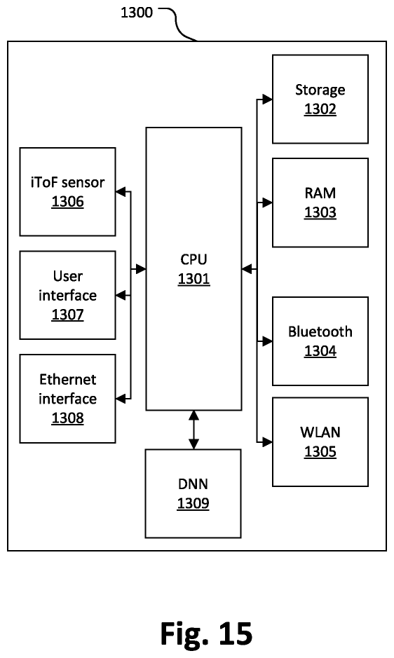

FIG. 15 schematically describes an embodiment of an iToF device that can implement the processes for performing ML-based multipath interference estimation and correction in sparse iToF devices by separating the direct and global components of a full-frame phasor image captured by the iToF device. The electronic device 1300 may further implement all other processes of a standard iToF/spot ToF system, like I-Q value determination, phase, and amplitude determination. The electronic device 1300 may further implement a DGS algorithm, a reflectance sharpening filter, or the like. The electronic device 1300 comprises a CPU 1301 as processor. The electronic device 1300 further comprises an iToF sensor 1306 and a deep neural network unit 1309 connected to the processor 1301. The electronic device 1300 further comprises a user interface 1307 that is connected to the processor 1301. This user interface 1307 acts as a man-machine interface and enables a dialogue between an administrator and the electronic system. For example, an administrator may make configurations to the system using this user interface 1307. The DNN 1309 may for example be an artificial neural network in hardware, e.g. a neural network on GPUs or any other hardware specialized for the purpose of implementing an artificial neural network. The DNN 1309 may thus be an algorithmic accelerator that makes it possible to use the technique in real-time, e.g., a neural network accelerator. The DNN 1309 may for example implement the ML-based regression model that realizes the processes described with regard to FIG. 3, FIG. 5, FIG. 6, FIG. 7 and FIG. 8 in more detail. The DNN1309 may optionally be a software. The electronic device 1300 further comprises a Bluetooth interface 1304, a WLAN interface 1305, and an Ethernet interface 1308. These units 1304, 1305 act as I/O interfaces for data communication with external devices. For example, video cameras with Ethernet, WLAN or Bluetooth connection may be coupled to the processor 1301 via these interfaces 1304, 1305, and 1308. The electronic device 1300 further comprises a data storage 1302, which may be the calibration storage, and a data memory 1303 (here a RAM). The data storage 1302 is arranged as a long-term storage, e.g. for storing the algorithm parameters for one or more use-cases, for recording iToF sensor data obtained from the iToF sensor 1306 the like. The data memory 1303 is arranged to temporarily store or cache data or computer instructions for processing by the processor 1301.

It should be noted that the description above is only an example configuration. Alternative configurations may be implemented with additional or other sensors, storage devices, interfaces, or the like. It should be further noted that alternatively the electronic device 1300 may be implemented with a digital signal processor (DSP) or a graphics processing unit (GPU), without limiting the present disclosure in that regard.

It should be further noted that a ToF sensor, a processor, or an application processor may implement the processes for long depth detection range measurement of a spot or a pixel in an iToF system.

It should also be noted that the division of the electronic device of FIG. 15 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure. The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

It should be recognized that the embodiments describe methods with an exemplary ordering of method steps. The specific ordering of method steps is however given for illustrative purposes only and should not be construed as binding. Changes of the ordering of method steps may be apparent to the skilled person.

The method of FIG. 14 can also be implemented as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the method described to be performed.

Note that the present technology can also be configured as described below.
(1) A method comprising applying a machine learning based model regression (Model_{θ}(Z)) to a phasor image (Z) captured by an iToF sensor (501) or phasor data (Z_{Ω}) obtained from the phasor image (Z) with spot illumination to obtain an estimate (Ź_{direct}) of the direct component of the phasor image (Z) and/or an estimate (Z_{global}) of the global component of the phasor image (Z).
(2) The method of (1), wherein the phasor data (Z_{Ω}) is single frequency spot-iToF data.
(3) The method of (1) or (2), wherein the machine learning based model regression (Model_{θ}(Z)) is applied to the phasor image (Z) to obtain an estimate (Ź_{global}) of the global component of the phasor image (Z), and wherein the method further comprises determining an estimate (Z_{direct}) of the direct component based on the estimate (\hat{Z}_{global}) of the global component and based on a phasor image (Z_{direct,global}).
(4) The method of anyone of (1) to (3), wherein the machine learning based model regression (Model_{θ}(Z)) in addition to the phasor image (Z) captured by an iToF sensor (501) or in addition to the phasor data (Z_{Ω}) obtained from the phasor image (Z) takes auxiliary data (W) as further input.
(5) The method of (4), wherein the auxiliary data (W) are data from other modes and frequencies, a full-frame infrared or grayscale image sampled by the same sensor or phasor images at higher or lower frequencies than the reference one.
(6) The method of (4), wherein the auxiliary data (W) is a multi-channel image that stacks data from different channels.
(7) The method of any one of (1) to (6), wherein the machine learning-based model regression (Model_{θ}(Z)) is pretrained based on one or more ground truth images (503) obtained based on direct/global separation (904) of transient image (X) of a model scene (902).
(8) The method of any one of (1) to (7), wherein the estimate (\hat{Z}_{direct}) of the direct component and the estimate (Ź_{global}) of the global component are sparse phasor images describing the direct and global components at the centers of the sparse spot illumination.
(9) The method of (8), wherein the method further comprises performing a concatenation (702) on one or more neighborhoods of the phasor image (Z) to obtain the phasor data (Z_{Ω}).
(10) The method of any one of (1) to (9), wherein the estimate (Z_{direct}) of the direct component and the estimate (Ź_{global}) of the global component are dense phasor images describing the direct and global components at the full resolution of the iToF sensor (501).
(11) A method for training a machine learning-based regression model (Model_{θ}(Z)), the method comprising generating training data comprising a direct ground truth phasor (907) and/or a global ground truth phasor (908) based on a 3D model/scene (902).
(12) The method of (11), wherein the method for training a machine learning-based regression model (Model_{θ}(Z)) further comprises training the machine learning-based regression model (Model_{θ}(Z)) based on the direct ground truth phasor (907) and/or the global ground truth phasor (908).
(13) The method of (11) or (12), wherein the method for training a machine learning-based regression model (Model_{θ}(Z)) further comprises determining a transient image (X) from the 3D model/scene (902).
(14) The method of (13), wherein the method for training a machine learning-based regression model (Model_{θ}(Z)) further comprises applying an iToF sensor model and optics (905) on the transient image (X).
(15) The method of any one of (11) to (14), wherein the method for training a machine learning-based regression model (Model_{θ}(Z)) further comprises applying a direct/global separation (904) to a transient image (X) to obtain the direct ground truth phasor (907) and/or the global ground truth phasor (908).
(16) The method of any one of (11) to (15), wherein the method for training a machine learning-based regression model (Model_{θ}(Z)) further comprises illuminating the 3D model/scene (902) by an illumination profile (901) and rendering the 3D model/scene (902) by a transient renderer (903) to obtain a transient image (X).
(17) An electronic device comprising circuitry configured to apply a machine learning based model regression (Model_{θ}(Z)) to a phasor image (Z) captured by an iToF sensor (501) with spot illumination to obtain an estimate (Z_{direct}) of the direct component of the phasor image (Z) and/or an estimate (Ź_{global}) of the global component of the phasor image (Z).
(18) An electronic device comprising circuitry configured to generate training data comprising a direct ground truth phasor (907) and/or a global ground truth phasor (908) based on a 3D model/scene (902).

1. A method comprising applying a machine learning model-based regression to a phasor image captured by an iToF sensor or phasor data obtained from the phasor image with spot illumination to obtain an estimate of the direct light component of the phasor image and/or an estimate of the global light component of the phasor image.

2. The method of claim 1, wherein the phasor data is single frequency spot-iToF data.

3. The method of claim 1, wherein the machine learning based model regression is applied to the phasor image to obtain an estimate of the global component of the phasor image, and wherein the method further comprises determining an estimate of the direct component based on the estimate of the global component and based on a phasor image.

4. The method of claim 1, wherein the machine learning based model regression in addition to the phasor image captured by an iToF sensor or in addition to the phasor data obtained from the phasor image takes auxiliary data as further input.

5. The method of claim 4, wherein the auxiliary data are data from other modes and frequencies, a full-frame infrared or grayscale image sampled by the same sensor or phasor images at higher or lower frequencies than the reference one.

6. The method of claim 4, wherein the auxiliary data is a multi-channel image that stacks data from different channels.

7. The method of claim 1, wherein the machine learning-based model regression is pretrained based on one or more ground truth images obtained based on direct/global separation of transient image of a model scene.

8. The method of claim 1, wherein the estimate of the direct component and the estimate of the global component are sparse phasor images describing the direct and global components at the centers of the sparse spot illumination.

9. The method of claim 8, wherein the method further comprises performing a concatenation on one or more neighborhoods of the phasor image to obtain the phasor data.

10. The method of claim 1, wherein the estimate of the direct component and the estimate of the global component are dense phasor images describing the direct and global components at the full resolution of the iToF sensor.

11. A method for training a machine learning model for direct and global light component regression, the method comprising generating training data comprising a direct ground truth phasor and/or a global ground truth phasor based on a 3D model/scene.

12. The method of claim 11, wherein the method for training a machine learning-based regression model further comprises training the machine learning-based regression model based on the direct ground truth phasor and/or the global ground truth phasor.

13. The method of claim 11, wherein the method for training a machine learning-based regression model further comprises determining a transient image from the 3D model/scene.

14. The method of claim 13, wherein the method for training a machine learning-based regression model further comprises applying an iToF sensor model and optics on the transient image.

15. The method of claim 11, wherein the method for training a machine learning-based regression model further comprises applying a direct/global separation to a transient image to obtain the direct ground truth phasor and/or the global ground truth phasor.

16. The method of claim 11, wherein the method for training a machine learning-based regression model further comprises illuminating the 3D model/scene by an illumination profile and rendering the 3D model/scene by a transient renderer to obtain a transient image.

17. An electronic device comprising circuitry configured to apply a machine learning model-based regression to a phasor image captured by an iToF sensor with spot illumination to obtain an estimate of the direct light component of the phasor image and/or an estimate of the global light component of the phasor image.

18. An electronic device comprising circuitry configured to generate training data comprising a direct ground truth phasor and/or a global ground truth phasor based on a 3D model/scene.
